(19) United States
(12) Patent Application Publication
(10) Pub. No.: US 2026/0099288 A1
(43) Pub. Date: Apr. 9, 2026

(54) PRINTER DRIVER OPTICAL CODE GENERATOR AND AUTOMATED DIGITAL WORKFLOW SYSTEM

(71) Applicant: CargoSense, Inc., Reston, VA (US)

(72) Inventor: Richard Allen Christopher KILMER, Centreville, CA (US)

(73) Assignee: CargpSense, Inc., Reston, VA (US)

(21) Appl. No.: 18/906,821

(22) Filed: Oct. 4, 2024

(51) Int. Cl. G06F 3/12; G06K 7/14

(52) U.S. Cl. CPC G06F 3/1285; G06F 3/1204; G06F 3/1257; G06K 7/1404

(57) ABSTRACT

A computer-implemented method is provided, comprising: receiving, at a printer driver, an instruction to print a digital document; in response to receiving the instruction to print the document, automatically transmitting, by the printer driver, the digital document to a server;

annotating the digital document with an optical code associated with a digital workflow to create an annotated digital document, wherein the optical code is configured to cause a device that scans the optical code to access stored information regarding the digital workflow; storing, in a database associated with the digital workflow, the annotated digital document; transmitting, by the server, the annotated digital document to the printer driver; and transmitting, from the printer driver to a printer, a command to print a physical copy of the annotated digital document.

### FIELD

This disclosure relates generally to physical and digital document management, and more specifically, to systems and methods of managing physical documents using optical codes associated with digital workflows.

### BACKGROUND

While some document workflows are entirely digital, many document workflows rely on both digital and physical versions of documents. For example, a digital document may be printed into a physical form as part of a workflow, and a recipient of the physical document may then later interact with the physical document as part of the workflow. In one example, modern supply chains rely heavily on documents that exist both in digital and physical form, such as packing slips that are generated digitally and printed for physical inclusion inside a shipping order to which the packing slip document pertains. Known solutions for generating printed packing slips and other physical documents for use in hybrid digital-physical workflows rely on conventional printing technology in which a printer driver rasterizes a digital source document into a format that can be used by a printer to create a printed page.

### SUMMARY

As described above, known solutions for generating printed packing slips and other physical documents for use in hybrid digital-physical workflows rely on conventional printing technology to generate physical copies of documents for use in the workflow. However, in known solutions, recipients of a physical copy of a document do not have an easy, reliable, and accurate way to access a digital version of the document or to otherwise quickly access a digital workflow associated with the document. And, from the perspective of the party generating physical documents for use in hybrid workflows, there does not exist an easy, reliable, and accurate solution to seamlessly ensure that all printed documents can automatically be associated with a hybrid workflow that is easily accessible by recipients of the physical document. Thus, it is difficult to ensure that all parties can seamlessly interact with a hybrid digital-physical workflow as physical documents are created by printing and physically exchanged between parties. For example, it is difficult in for parties in various business and supply chain operations to interact with, validate, or modify information represented in a physical document such as a packing slip as it passes between different parties throughout the operation.

Accordingly, there is a need for improved systems and methods for creating physical documents that are linked to digital workflows, such that the physical documents allow easy, reliable, accurate, and flexible access by different parties to digital workflows that are associated with the physical document. Disclosed herein are systems and methods that may address one or more of the above-identified needs.

Described herein are systems and methods for automating digital workflows associated with physical and digital copies of documents. The systems and methods described herein utilize a specialized printer driver, which is referred to herein as an optical code printer driver. The optical code printer driver may fulfill the functions of a standard printer driver in that it may receive print jobs from an operating system, rasterize the document to be printed, and send the rasterized document to the printer for printing. However, the optical code printer driver may also seamlessly provide additional functionality to automatically integrate printed documents into digital workflows, and to ensure that printed copies of the documents allow for simple access to said digital workflows by various parties to whom the physical documents may be passed.

As explained herein, when the optical code printer driver is selected by a user for printing a digital document, the optical code printer driver may automatically extract and analyze information in the document to be printed, and may cooperate with a server to automatically allocate the document to a digital workflow (either by associating it with an existing digital workflow or by generating a new digital workflow for the document). The digital workflow may include, for example, a series of steps or tasks that involve the use of a document in achieving part or all of an end goal. One or more steps of this digital workflow may be preconfigured by an end user via an end user interface, and some or all of these steps may be performed autonomously. Once the document has been allocated to the digital workflow by the server, information extracted from the document may be stored in one or more databases associated with the digital workflow.

In addition to extracting information from the document to be printed and associating it with a digital workflow, the optical code printer driver (in cooperation with the server) may annotate the digital document to be printed with an optical code (e.g., a QR code), wherein the optical code may uniquely link the printed document with the digital version of the document and enable interaction with the digital workflow. In this manner, the mere act of printing the physical document may allow the document to automatically be configured for use in a digital workflow, and to automatically be annotated with a physical optical code allowing seamless interaction with the digital workflow.

Once printed, a recipient of the physical document may be able to scan the optical code that is associated with the underlying digital workflow, triggering the occurrence of the one or more automated steps of the workflow. For example, if the workflow involves collecting wet signatures on a document, a recipient of the physical document may scan the optical code with a mobile device and may be automatically prompted to take a photo of the document with their wet signature, which may cause the digital version of the document to be updated with the signature and automatically stored in a database and/or sent to a next recipient in the workflow for a subsequent signature. In another example, if the workflow involved validation of items listed on a packing slip, the a recipient of a printed packing slip may scan the optical code with a mobile device and may be automatically prompted to enter inputs into a graphical user interface to validate that all items listed on the packing slip were in fact included in the shipment; this validation information may then be automatically stored in a database and/or sent to other parties in the supply chain.

In some examples, instead of a printer driver, an email client plugin may be similarly configured to automatically extract email content from the email body and/or from attachments, and to automatically add a document attached to an email (e.g., a PDF) to a digital workflow upon a sender emailing the document. Optionally, an optical code may be automatically added to email attachment documents that are processed by the email client plugin, allowing interaction with digital workflows by users who scan the optical code.

As such, the systems and methods described herein improve the efficiency of managing physical documents with digital workflows while also expanding upon the technical capabilities of existing printer drivers and email client plugins.

In some embodiments, a computer-implemented method is provided, comprising: receiving, at a printer driver, an instruction to print a digital document; in response to receiving the instruction to print the document, automatically transmitting, by the printer driver, the digital document to a server; annotating, by the server, the digital document with an optical code associated with a digital workflow to create an annotated digital document, wherein the optical code is configured to cause a device that scans the optical code to access stored information regarding the digital workflow; storing, in a database associated with the digital workflow, the annotated digital document; transmitting, by the server, the annotated digital document to the printer driver; and transmitting, from the printer driver to a printer, a command to print a physical copy of the annotated digital document.

In some embodiments, the computer-implemented method comprises extracting, by the server, data from the digital document; and storing, in the database associated with the digital workflow, the information extracted from the digital document.

In some embodiments, the computer-implemented method comprises configuring, by the server, the digital workflow, wherein configuring the digital workflow comprises one or more of the following steps: defining steps of the digital workflow, defining an order of steps of the digital workflow, defining parties associated with the digital workflow, defining permissions for different parties to the digital workflow, and defining information to be solicited from different parties to the digital workflow.

In some embodiments, the computer-implemented method comprises, upon receipt of the digital document from the printer driver, automatically determining, by the server, a document type of the digital document based on digital document data; and allocating, by the server, the digital document to the digital workflow based on the determined document type.

In some embodiments, determining, by the server, a document type of the digital document based on digital document data comprises parsing, by the server, the digital document data from the digital document.

In some embodiments, the optical code corresponds uniquely to the digital workflow.

In some embodiments, the optical code corresponds uniquely to the digital document.

In some embodiments, the optical code is a QR code, a bar code, or a bit code.

In some embodiments, the computer-implemented method comprises determining, by the server, based on the digital workflow, a destination device to receive the annotated digital document; and transmitting, by the server, to the destination device, the annotated digital document.

In some embodiments, the computer-implemented method comprises determining, by the server, based on the digital workflow, an intended recipient to receive the annotated digital document; and uploading, by the server, the annotated digital document to a profile associated with the intended recipient.

In some embodiments, the computer-implemented method comprises receiving, by the server, a signal from a remote device of a possessor of the physical copy of the annotated document indicating that the optical code has been scanned by the possessor; and transmitting, by the server, a signal instructing the remote device to display a graphical user interface associated with the digital workflow.

In some embodiments, the computer-implemented method comprises receiving, by the server, from the remote device of the possessor of the physical copy, information provided via the graphical user interface associated with the digital workflow; and storing the information provided via the graphical user interface in the database in association with the digital workflow.

In some embodiments, the computer-implemented method comprises determining, by the server, an identity of the possessor based on the signal from the remote device; and authenticating, by the server, the possessor based on the identity of the possessor and the digital workflow, wherein transmitting the instruction to display the graphical user interface is performed in accordance with one or both of determining and authenticating the identity of the possessor.

In some embodiments, the computer-implemented method comprises transmitting, by the server, to an end user device, a signal indicating a proposed digital workflow of the digital document and instructions for the end user device to display visual affordances for approving or rejecting the proposed digital workflow; receiving, by the server, a signal from the end user device indicating an end user selection of the visual affordance for approving the proposed digital workflow; and allocating, by the server, the digital document to the approved digital workflow in response to receiving the signal indicating that the proposed digital workflow has been approved.

In some embodiments, annotating, by the server, the digital document with an optical sensor associated with the digital workflow to create an annotated digital document comprises creating a PDF of the annotated digital document.

In some embodiments, a system is provided, comprising: one or more processors; and memory storing instructions stored in the memory, which, when executed by the one or more processors, cause the system to: receive, at a printer driver, an instruction to print a digital document; in response to receiving the instruction to print the document, automatically transmit, by the printer driver, the digital document to a server; annotate, by the server, the digital document with an optical code associated with a digital workflow to create an annotated digital document, wherein the optical code is configured to cause a device that scans the optical code to access stored information regarding the digital workflow; store, in a database associated with the digital workflow, the annotated digital document; transmit, by the server, the annotated digital document to the printer driver; and transmit, from the printer driver to a printer, a command to print a physical copy of the annotated digital document.

In some embodiments, the system is further caused to: extract, by the server, data from the digital document; and store, in the database associated with the digital workflow, the information extracted from the digital document.

In some embodiments, the system is caused to: configure, by the server, the digital workflow, wherein configuring the digital workflow comprises one or more of the following steps: defining steps of the digital workflow, defining an order of steps of the digital workflow, defining parties associated with the digital workflow, defining permissions for different parties to the digital workflow, and defining information to be solicited from different parties to the digital workflow.

In some embodiments, the system is caused to: upon receipt of the digital document from the printer driver, automatically determine, by the server, a document type of the digital document based on digital document data; and allocate, by the server, the digital document to the digital workflow based on the determined document type.

In some embodiments, determining, by the server, a document type of the digital document based on digital document data comprises parsing, by the server, the digital document data from the digital document.

In some embodiments, the optical code corresponds uniquely to the digital workflow.

In some embodiments, the optical code corresponds uniquely to the digital document.

In some embodiments, the optical code is a QR code, a bar code, or a bit code.

In some embodiments, the system is further caused to: determine, by the server, based on the digital workflow, a destination device to receive the annotated digital document; and transmit, by the server, to the destination device, the annotated digital document.

In some embodiments, the system is further caused to: determine, by the server, based on the digital workflow, an intended recipient to receive the annotated digital document; and upload, by the server, the annotated digital document to a profile associated with the intended recipient.

In some embodiments, the system is further caused to: receive, by the server, a signal from a remote device of a possessor of the physical copy of the annotated document indicating that the optical code has been scanned by the possessor; and transmit, by the server, a signal instructing the remote device to display a graphical user interface associated with the digital workflow.

In some embodiments, the system is further caused to: receive, by the server, from the remote device of the possessor of the physical copy, information provided via the graphical user interface associated with the digital workflow; and store the information provided via the graphical user interface in the database in association with the digital workflow.

In some embodiments, the system is further caused to: determine, by the server, an identity of the possessor based on the signal from the remote device; and authenticate, by the server, the possessor based on the identity of the possessor and the digital workflow, wherein transmitting the instruction to display the graphical user interface is performed in accordance with one or both of determining and authenticating the identity of the possessor.

In some embodiments, the system is further caused to: transmit, by the server, to an end user device, a signal indicating a proposed digital workflow of the digital document and instructions for the end user device to display visual affordances for approving or rejecting the proposed digital workflow; receive, by the server, a signal from the end user device indicating an end user selection of the visual affordance for approving the proposed digital workflow; and allocate, by the server, the digital document to the approved digital workflow in response to receiving the signal indicating that the proposed digital workflow has been approved.

In some embodiments, annotating, by the server, the digital document with an optical sensor associated with the digital workflow to create an annotated digital document comprises creating a PDF of the annotated digital document.

In some embodiments, a computer-implemented method is provided, comprising: receiving, via an email client program, an instruction to email a digital document; in response to the email client program receiving the instruction to send the document, automatically transmitting, by an email plugin, the digital document to a server; annotating, by the server, the digital document with an optical code associated with a digital workflow to create an annotated digital document, wherein the optical code is configured to cause a device that scans the optical code to access stored information regarding the digital workflow; storing, in a database associated with the digital workflow, the annotated digital document; transmitting, by the server, the annotated digital document to the email plugin; and sending, by the email client program, an email comprising the annotated digital document.

In some embodiments, a computer-implemented method is provided, comprising: receiving, at a printer driver, an instruction to print a digital document; in response to receiving the instruction to print the document, automatically transmitting, by the printer driver, the digital document to a server; storing, in a database associated with a digital workflow, the digital document; transmitting, by the server, an instruction to the printer driver to annotate the document with an optical code associated with the digital workflow to create an annotated digital document, wherein the optical code is configured to cause a device that scans the optical code to access stored information regarding the digital workflow; annotating, by the printer driver, the digital document with the optical code; and transmitting, from the printer driver to a printer, a command to print a physical copy of the annotated digital document.

In some embodiments, a system is provided, comprising: one or more processors; and memory storing instructions, which, when executed by the one or more processors, cause the system to: receive, at a printer driver, an instruction to print a digital document; in response to receiving the instruction to print the document, automatically transmit, by the printer driver, the digital document to a server; store, in a database associated with a digital workflow, the digital document; transmit, by the server, an instruction to the printer driver to annotate the document with an optical code associated with the digital workflow to create an annotated digital document, wherein the optical code is configured to cause a device that scans the optical code to access stored information regarding the digital workflow; annotate, by the printer driver, the digital document with the optical code; and transmit, from the printer driver to a printer, a command to print a physical copy of the annotated digital document.

In some embodiments, a non-transitory computer-readable storage medium is provided, the computer-readable storage medium storing instructions that, when executed by one or more processors of a system comprising memory, cause the system to: receive, at a printer driver, an instruction to print a digital document; in response to receiving the instruction to print the document, automatically transmit, by the printer driver, the digital document to a server; store, in a database associated with a digital workflow, the digital document; transmit, by the server, an instruction to the printer driver to annotate the document with an optical code associated with the digital workflow to create an annotated digital document, wherein the optical code is configured to cause a device that scans the optical code to access stored information regarding the digital workflow; annotate, by the printer driver, the digital document with the optical code; and transmit, from the printer driver to a printer, a command to print a physical copy of the annotated digital document.

In some embodiments, a computer-implemented method is provided, comprising: receiving, at a printer driver, an instruction to print a digital document; in response to receiving the instruction to print the document: automatically annotating the document with an optical code associated with a digital workflow to create an annotated digital document, wherein the optical code is configured to cause a device that scans the optical code to access stored information regarding the digital workflow; and automatically storing, in a database associated with the digital workflow, the digital document; and transmitting, from the printer driver to a printer, a command to print a physical copy of the annotated digital document.

In some embodiments, a system is provided, comprising one or more processors; and memory storing instructions, which, when executed by the one or more processors, cause the system to: receive, at a printer driver, an instruction to print a digital document; in response to receiving the instruction to print the document: automatically annotate the document with an optical code associated with a digital workflow to create an annotated digital document, wherein the optical code is configured to cause a device that scans the optical code to access stored information regarding the digital workflow; and automatically store, in a database associated with the digital workflow, the digital document; and transmit, from the printer driver to a printer, a command to print a physical copy of the annotated digital document.

In some embodiments, a non-transitory computer-readable storage medium storing instructions is provided, that, when executed by one or more processors of a system comprising memory, cause the system to: receive, at a printer driver, an instruction to print a digital document; in response to receiving the instruction to print the document: automatically annotate the document with an optical code associated with a digital workflow to create an annotated digital document, wherein the optical code is configured to cause a device that scans the optical code to access stored information regarding the digital workflow; and automatically store, in a database associated with the digital workflow, the digital document; and transmit, from the printer driver to a printer, a command to print a physical copy of the annotated digital document.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary method for printing a document using an optical code printer driver linked to a digital document workflow management system, according to some embodiments.

FIG. 2 illustrates a document annotated with an optical code, according to some embodiments.

FIG. 3 illustrates an exemplary user interface for accessing an optical code printer driver, according to some embodiments.

FIG. 4 illustrates an exemplary user interface for accessing an optical code email client plugin, according to some embodiments.

FIG. 5 illustrates an exemplary hybrid digital-physical document processing workflow for validating shipping contents listed on a packing slip, according to some embodiments.

FIG. 6 illustrates an exemplary workflow for obtaining and/or validating document signatures, according to some embodiments.

FIG. 7 illustrates an exemplary workflow for obtaining and/or validating document signatures, according to some embodiments.

FIG. 8 illustrates an exemplary system for implementing an optical code printer driver and associated digital document workflow management system, according to some embodiments.

FIG. 9 illustrates a computer, according to some embodiments.

### DETAILED DESCRIPTION

Described herein are systems and methods using a specialized printer driver, referred to herein as an optical code printer driver, to help to automate digital workflows that can improve the ease and efficiency of gathering and managing digital data as parties interact with physical printed documents. As described herein, an optical code printer driver may be configured to extract content from documents sent to the printer driver, associate the document and document contents with a digital workflow and/or associated database entries, generate and/or retrieve an optical code (e.g., a QR code) associated with the document and/or the digital workflow, annotate the digital document to be printed with the optical code, and then send the annotated document to a printer for printing with the optical code. In this manner, an optical code may be uniquely paired with a digital workflow such that data embodying the functionalities of the digital workflow are accessible via the optical code.

An end user may be able to automatically add a physical document to a digital workflow (or create a new digital workflow) simply by printing a document. For example, when the optical code printer driver receives a document from an operating system for printing, the optical code printer driver may transmit a digital copy of the document to be printed to an associated server, which may determine the type of document (e.g., whether the document is a contract, a receipt, etc.) and may allocate the document to a digital workflow. The digital workflow may be a preexisting digital workflow or may be one that is newly created for the document being printed. Settings for the digital workflow may be automatically determined by the server based on the determined document type and/or based on other information extracted from the document. In some embodiments, end users may be able to configure settings for various digital workflows, including defining steps in the workflow, permissions for various users, information to be displayed and/or uploaded during the workflow, and the like.

In some examples, the server may be in communication with a database and may transmit document data and/or the annotated copy of the document to be stored in the database.

The server may also be configured to annotate the digital document with the optical code that is associated with the particular workflow, thereby creating an annotated copy of the digital document.

The printer driver may then receive the annotated document, including said optical code, from the server and may transmit the copy of the document to a printer for printing. In this manner, a document may be automatically added to a digital workflow and annotated with an optical code for managing the document within the digital workflow through the mere act of printing the document using the printer driver. The optical code may then be scanned by recipients of the physical document so that information regarding the physical document's location and status may be uploaded and saved in a database associated with the digital workflow, thereby reducing the gap between physical and digital document management. Upon scanning the optical code, depending on configurations of the associated digital workflow, a user may be automatically prompted to perform different tasks and/or to upload different information, such as photographing a wet signature, verifying shipping contents listed on a packing slip, and/or entering location or identity information. Additionally, since a user would ordinarily need to print a document as part of a supply chain or business operation, incorporating the automatic workflow designation capabilities into a printer driver and server may save the user time and reduce the amount of steps required to perform the workflow allocation of the physical document.

As such, the systems and methods described herein improve the efficiency of managing physical documents with digital workflows, by leveraging a specialized printer driver to automatically extract and save information from documents to be printed, automatically associate said documents with a digital workflow, automatically annotate said documents to be printed with an optical code providing future digital access to said digital workflow for parties in possession of the printed physical document.

In some examples, an email plugin may be configured to automatically allocate a document attached to an email to a digital workflow upon a user sending the email in a similar manner as the printer driver described above. This can provide an additional mechanism for improving the efficiency of managing digital workflows associated with emailed documents.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus.

Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

### Exemplary Method

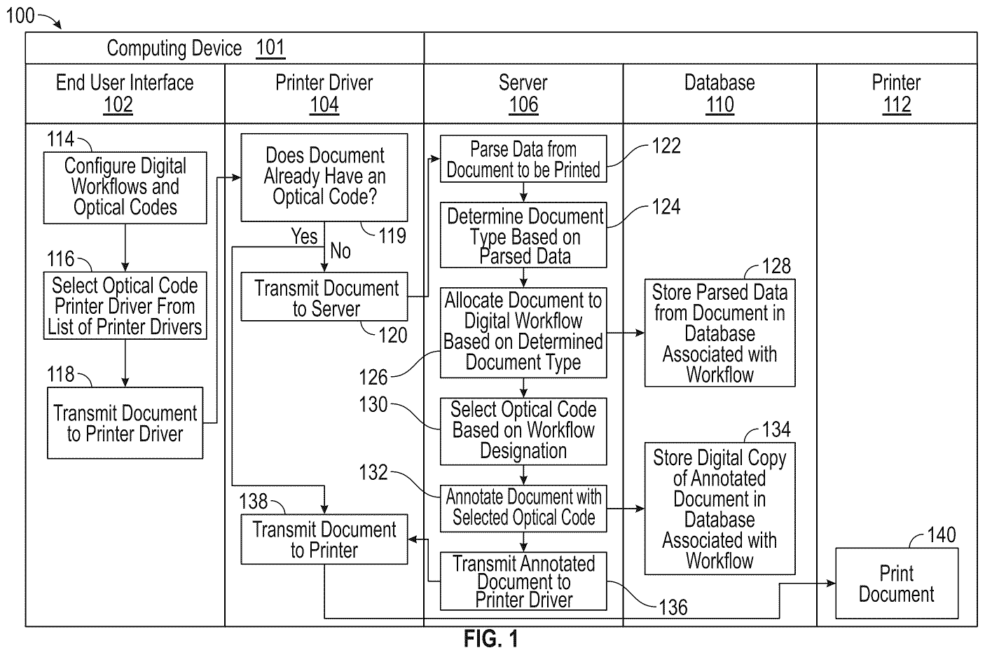

FIG. 1 illustrates an exemplary method 100 for printing a document using an optical code printer driver linked to a digital document workflow management system. At block 114, an end user may configure a digital workflow. As used herein, a “digital workflow” may refer to a series of steps or tasks that are performed partially or completely electronically and have an end goal or objective that may be performed by one or more different parties in association with digital and/or physical documents and/or assets. A user may configure a digital workflow, for example, by configuring instructions for routing inputs and outputs to/from different software applications, programs, or systems at different steps of the digital workflow. Additionally, a user may configure a digital workflow by defining steps of the digital workflow, such as criteria that should be met before moving onto the next step, defining an order of steps of the digital workflow, defining parties associated with the digital workflow (senders, recipients, signatories, etc.), defining permissions for different parties to the digital workflow (e.g. distinguishing between managers, administrators, internal/external personnel, etc.), and defining information to be solicited from different parties to the digital workflow (e.g. signatures, contact information, status information of shipped goods, etc.). In some examples, a user may configure a digital workflow via a program stored on or hosted by a server 106. In some examples, a user may be provided with an end user interface 102 (e.g., a graphical user interface) that allows the user to select from various options to configure what steps are performed as part of a workflow; in what order those steps are performed; what information is displayed, requested, and/or uploaded during each step; and what parties have what permissions with respect to different information and different steps in the workflow. In some examples, one or more steps in a digital workflow may be distributed across multiple servers, systems, or computing environments.

One or more steps of a digital workflow may be automated. One or more steps of a digital workflow may also involve the use of an artificial intelligence (AI) model, such as an LLM (e.g., GPT-4, GPT-4o, Arctic-TILT, or Google Gemini) and/or an AI agent (e.g., Azure Assistants, Autogen Agents, CrewAI Agents, and/or LangChain Agents). If a step or task of the digital workflow involves the use of a specialized AI model, block 114 may include training an AI model with training data based on its particular role in the digital workflow.

While the description above contemplates that an end user may manually configure steps in a workflow, in some embodiments a workflow may be automatically configured using AI, or preconfigured workflows may be selected from a list of options. This step may take place before sending a document to a printer driver for printing as described below, or it may take pace after (e.g., in response to) sending a document to a printer driver for printing as described below.

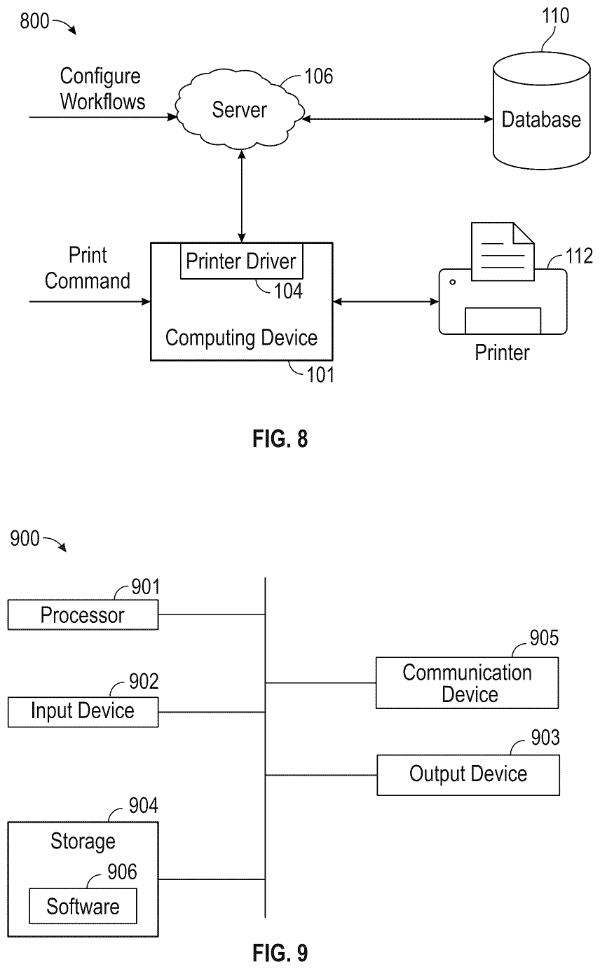

Referring still to FIG. 1, in examples involving documents, method 100 may involve the use of an optical code printer driver 104 (see FIG. 8 below). Optical code printer driver 104 may include software that is configured to extract information from documents to be printed, optionally including determining whether a document has already been annotated with an optical code. Based on a preexisting optical code included in the document to be printed, the system may extract information encoded in the optical code and may look up information stored in association with the optical code and may accordingly determine that the document is already associated with a preexisting digital workflow. Alternatively, the system may determine that the document does not have an optical code and thus has not yet been allocated to a particular workflow and may responsively generate (or prompt a user to generate) a new digital workflow to be associated with the document. To extract information from digital documents to be printed, optical code printer driver 104 may be configured with an object detection model, (e.g., SSD, YOLO, Faster R-CNN, etc.) to perform this function.

Optical code printer driver 104 may be configured to communicate with a server 106. As described in further detail below, in some examples, server 106 may be configured to allocate the document to a digital workflow and annotate the document with the optical code that is associated with that particular workflow. In some examples, server 106 may host or store a program that is configured to perform the workflow allocation and optical code annotation. In other examples, instead of the annotation of the document being performed by the server, the server 106 may return the contents of an optical code (e.g. a URL linking to a particular location that is to be encoded in the optical code) to the optical code printer driver 104. In these examples, optical code printer driver 104 may perform the annotation of the document prior to sending the document to the physical printer. Any of the features of any of the embodiments in which annotation is performed at a server or locally at the printer driver can be combined with each other. In embodiments in which the document is annotated by the server and in embodiments in which the document is annotated by the printer driver, the version of the document that is stored in the database may itself be stored in annotated form and/or in non-annotated form. In embodiments in which the document is stored in non-annotated form, metadata stored in association with the document in the database may indicate the optical code that was applied to the document before printing.

At block 116, a user may select optical code printer driver 104 from a list of printer drivers for printing a physical copy of a digital document. For example, as shown in FIG. 3, printer driver 104 may be selected by a user from a dropdown list of other printer drivers installed on their device, depending on the application from which the user is printing the document (e.g., Microsoft Word, Adobe Acrobat), or an end user interface 102. At block 118, upon the user selection of the optical code printer driver 104, the document may be transmitted to the optical code printer driver, for example in response to a user executing a command to “print”from end user interface 102.

At block 119, the optical code printer driver 104 may determine whether the document to be printed by the user already has an optical code or not. In some embodiments, this determination may be made locally at printer driver 104, while in other embodiments this determination may be made remotely at server 106 after the document is transmitted to server 106. If it is determined that the document already has an optical code associated with a digital workflow, then in some embodiments the document may be printed immediately, for example, by transferring the document from the printer driver to a printer at block 138. Thus, blocks 120-136 may optionally be bypassed. Alternatively, if the optical code printer driver 104 determines that the document does not already have an optical code, then one or more of blocks 120-136 may be performed, for example, starting with the printer driver transmitting the document to the server 106 at block 120 for further processing. In some examples, optical code printer driver 104 may be configured to perform any of the tasks in blocks 120-136 that are shown in FIG. 1 as being performed at the server 106.

At block 122, server 106 (or, e.g., via one or more programs hosted thereon) may extract, read, and/or parse data from the document that it received from the optical code printer driver 104. Parsing the data from the document may include extracting information on the layout and content of the document, such as a document title, headings, section titles, lists, tables, form fields, terms and conditions, and signature blocks. Server 106 may utilize one or more optical character recognition (OCR models), image analysis models, and/or document AI models (e.g., an LLM such as GPT-4, GPT-4o, Arctic-TILT, or Google Gemini) for parsing data from the document received from the optical code printer driver 104. In some examples, the document AI model may be trained from training data that includes various types of documents (e.g., different contracts, receipts, supply chain documents, and the like). The document AI model may be trained by validating the accuracy of the data types parsed by the document AI model (e.g., validating that information parsed as a signature block is, in fact, a signature block) as well as validating the accuracy of the document AI model's document type prediction based on the parsed data.

At block 124, server 106 may determine a document type based on the document data. For example, server 106 may analyze the parsed data and may determine that a combination of headings, key terms, and signature blocks are indicative of a legal document such as a contract (e.g., a licensing agreement, a bill of lading, etc.). In other examples, server 106 may analyze the parsed data and may determine that a combination of headings, lists, and the absence of signature blocks are indicative of a receipt (e.g., a packing slip or an invoice). At block 126, server 106 may allocate the document to a digital workflow based at least in part on the determined document type in block 124. For example, server 106 may factor in the type of document (e.g., a bill of lading) as well as the substance of the document (e.g., a specific type of goods being shipped) in allocating the document to a digital workflow (e.g., a digital workflow associated with the underlying transaction for which the bill of lading is being issued). This process may use additional databases of information available to server 106 to integrate existing data, together with the document data, to enable the digital workflow.

For example, server 106 may determine that the type of document (e.g., a packing list) is associated with a customer purchase order, the data of which is stored in a separate database. Based on a reference in the document (e.g., a purchase order number) the purchase order data could be retrieved by server 106 to enhance the data associated with the digital workflow. In this example, an outbound Advanced Shipping Notification (ASN) workflow could be automatically performed by comparing the quantities of items listed in the packing list against the original customer purchase order quantities and notifying the customer that their requested quantities are being shipped.

Additionally, or alternatively, the identity of the user who is signed into the computing device 101, at which the print operation is being performed, may be considered by server 106 in proposing a digital workflow and/or allocating a digital document to a particular workflow. For instance, an administrator or manager may log into computing device 101 with their login credentials prior to printing a document. Server 106 may be configured to, based on the credentials used to log in to computing device 101, determine the identity of the user (e.g. their name, job title, etc). Server 106 may be configured to account for the user's identity as it proposes digital workflow allocations. For example, server 106 may identify that the user printing the document is a manager and may propose or automatically allocate the document to a digital workflow that involves at least one step requiring a manager's signature, for example.

In some examples, an end user may be able to review and approve of a proposed digital workflow allocation (e.g., selection of a preexisting workflow, generation of a workflow, and/or workflow settings) before the document is allocated to the digital workflow and may have the option to modify (or cancel) a digital workflow allocation. For example, server 106 may transmit a signal to an end user's computing device 101 to display an indication of a proposed digital workflow for a document, with the proposed digital workflow determined based on the type of document. In some examples, server 106 may transmit instructions to computing device 101 to display a set of visual affordances in the end user interface 102 for approving of a proposed digital workflow designation. A user may select a visual affordance (e.g., a button, icon, etc.) for approving or denying the proposed digital workflow designation, for example, by clicking or pressing an “approve” or “deny” button. Upon the end user's selection of the visual affordance for approving the proposed digital workflow, computing device 101 may transmit a signal to server 106 indicating as such, and the server may proceed to allocating the digital document to the approved digital workflow.

At block 128, server 106 may store the parsed data from the document in a database 110 that is associated with the workflow. Database 110 may be, for example, a database that stores document and workflow information for one or more workflows. In some embodiments, document data from different workflows may be stored in common databases or may be stored in separate databases that are specific to a particular workflow, a particular kind of workflow, and/or a particular organization or entity. In some examples, database 110 is a generalized database such that document data from many different workflows is stored at different locations within the same database 110. By storing the document data in database 110, that information may be accessed by other software programs or applications within the digital workflow that may use the document data in performing their particular roles. Furthermore, the document data may be viewed, augmented, deleted, and/or modified by users downstream in the document workflow, allowing digital interaction from different parties all interacting with the same document workflow. However, in other examples, document data may not be parsed by the server 106, and structured data may be stored in the database 110 for use by one or more downstream applications.

At block 130, server 106 may select an optical code based on the document's workflow designation, and at block 132, the document may be annotated with the selected optical code. Selecting an optical code may include selecting a preexisting optical code or generating a new optical code. The selected optical code may be associated with the particular digital workflow that was determined at document 124. In some embodiments, an optical code may have a one-to-one correspondence with a particular digital workflow. In some embodiments, an optical code may have a one-to-one correspondence with a particular document that is part of a multi-document workflow. The selected (or generated) optical code may encode information that points to a network location at which information about the document identity, associated workflow(s), document contents, various user permissions, and associated metadata may be stored. Although block 132, the annotation of the document with an optical code, is shown as being performed at server 106, in some examples, the document may be annotated with an optical code by printer driver 104.

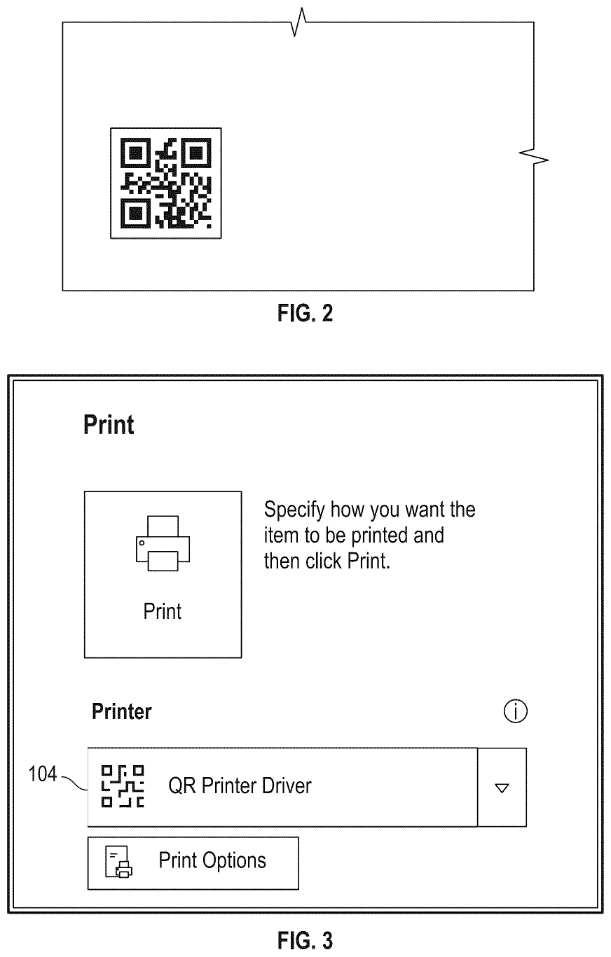

When the optical code is scanned by the optical sensor on the device, the device may access (e.g., access a network location indicated by a URL, make an API call, etc.) information within the digital workflow based on information that has been encoded in the optical code, so that the device may transmit data to and from this location in the workflow. Through this association between an optical code and a location within a digital workflow, digital or physical documents or objects (e.g., packages, envelopes, etc.) to be used in one or more steps of the workflow can be annotated with the optical code. An example of a document annotated with an optical code is shown in FIG. 2. In some examples, the optical code may be a QR code, a bar code, or a bit code.

In this manner, a “link” can be created between the object and the digital workflow that identifies, or “tags” the object as belonging to a particular workflow. Through “tagging” objects, such as documents, with an optical code, information about the status or content of an object can be accurately and automatically uploaded to the correct digital workflow by a recipient scanning the optical code. This can eliminate the need for the recipient to manually search for the correct workflow associated with the object. Businesses and supply chains may have a large number of workflows with varying levels of complexity, so this capability may help businesses and supply chains improve the efficiency of their operations and of the exchange of data between different points in a digital workflow.

Additionally, documents can be associated or “linked” together via their optical codes. An optical code of one document may contain encoded information that points or links to another document. As such, scanning the optical code of one document may cause a prompt to be displayed on a user's device directing them to the scan the other linked document. For instance, if a bill of lading having an optical code is scanned by a user's device, a prompt may be provided that directs the user to scan an optical code of a packing list in response to the user scanning the optical code on the bill of lading. Additionally, or alternatively, a digital copy of the packing list may be displayed in response to the user scanning the optical code on the bill of lading. By supporting the association of documents via their optical codes, this can make it easier to recall copies of other documents even when the user does not have physical possession of both documents.

Once the document is annotated with the optical code, at block 134, a digital copy of the document having the annotated optical code (e.g., a PDF copy of the annotated document) may be stored in the database 110 associated with the particular workflow. This copy may be stored in addition to extracted data from the document, which may be stored in a structured format. The stored copy of the annotated document may be stored with timestamped metadata reflecting the time at which it was sent to the printer driver. The stored copy of the annotated document may also contain stored metadata indicating the identity of the user who printed the document, such as their name, login credentials, and the like.

At block 136, the annotated digital copy of the document may be transmitted by the server back to the printer driver 104, which may then transmit the annotated document to the printer at block 138. In some examples, method 100 includes printing a physical copy of the annotated document using a printer 112 at block 140.

In accordance with method 100 described above, the end user's simple act of instructing a document to print using the conventional print instruction of an operating system user interface may seamlessly invoke the specialized optical printer driver described herein, and may thus result in the allocation of the document to a digital workflow, the parsing and storage of data from the document, and the annotation of the document with an optical code for easy access to the digital workflow as the physical document is moved through a physical workflow amongst various locations and parties.

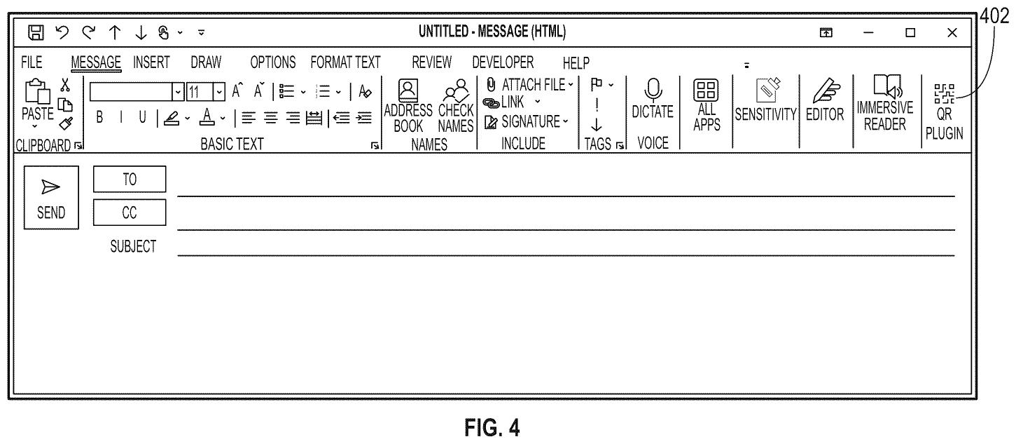

In some examples, as shown in FIG. 4, an optical code email client plugin 402 may be configured with similar functionalities as the optical code printer driver 104. An optical code email client plugin 402 may be used to automatically allocate emailed documents (and/or content within the body of an email) into digital workflows. For example, a user may add a file as an attachment to an email of an email client program and may select the optical code plugin 402. The optical code plugin 402 may transmit the attached file to a server when the email is sent with the attachment. In some embodiments, a user may be required to manually select or approve of running the email client plugin functionality for emails being sent. In some embodiments, the email client plugin may run automatically whenever an email is sent, or whenever an email with a document attachment is sent. The optical code plugin 402 may similarly determine whether the attached file already has an optical code. If the attached file already has an optical code, the optical code plugin may transmit a copy of the attached file to the server, and the server may update the annotated digital copy of the file within the database to reflect the new copy of the document being emailed (and to store any extracted information that is included in the new copy of the document). If the attached file does not already have an optical code, then a series of steps similar to, or the same as, steps 122 to 136 described with respect to FIG. 1 may be performed by the email client plugin or the server to annotate the attached file with an optical code and allocate the attached file to a digital workflow.

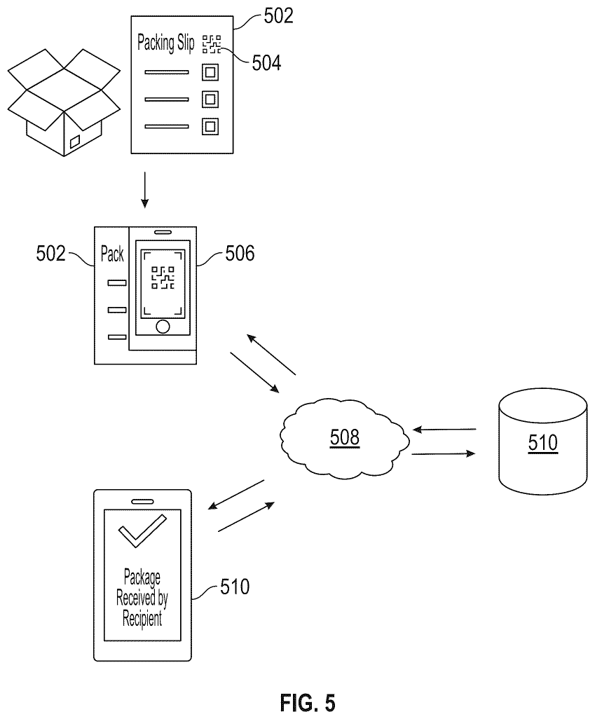

Turning to FIGS. 5-7, examples of workflows involving the use of physical documents annotated with an optical code are provided. FIG. 5 illustrates the use of a physical packing slip document having an optical code that allows a recipient of the packing slip to access a digital workflow for verifying that shipping contents match the physical packing slip. As shown, a printer driver system as described herein has annotated physical document 502 with an optical code 504 associated with a digital workflow. An optical sensor on a recipient's computing device 506 (e.g., a camera on a cell phone, tablet, etc.) may scan the optical code on the physical document 502. The recipient's computing device 506 may then access server 508 comprising information decoded from the optical code. Upon receipt of the signal from the recipient's computing device 506, the server 508 may determine that the recipient has received the document associated with the optical code and may store information in database 510 indicating receipt of the document, timestamp information, and/or information about the recipient device (or associated user) that scanned the code. The server 508 may make this determination, for example, by reading recipient information (e.g., a recipient's login credentials, their device ID, or an IP address of the recipient's device).

When the server 508 determines that the recipient has received the document, server 508 may then transmit a signal to a sender's computing device 510 notifying the sender that the document has been received by the recipient. Then, server 508 may update digital workflow data that is stored in database 510 to indicate that the package has been received by the recipient, and the digital workflow may advance to the next step if applicable.

In some embodiments, the server may send an instruction to the recipient's device 506 causing the recipient's device to display a graphical user interface including a prompt for verification of information on the document. For example, the user may be prompted to verify that contents listed on the packing slip are present and safely received in the shipment in which the packing slip was included. Upon the user entering that information into device 506, device 506 may transmit that information back to server 508, and the information may then be stored in database 510 in association with the shipment workflow for the packing slip document.

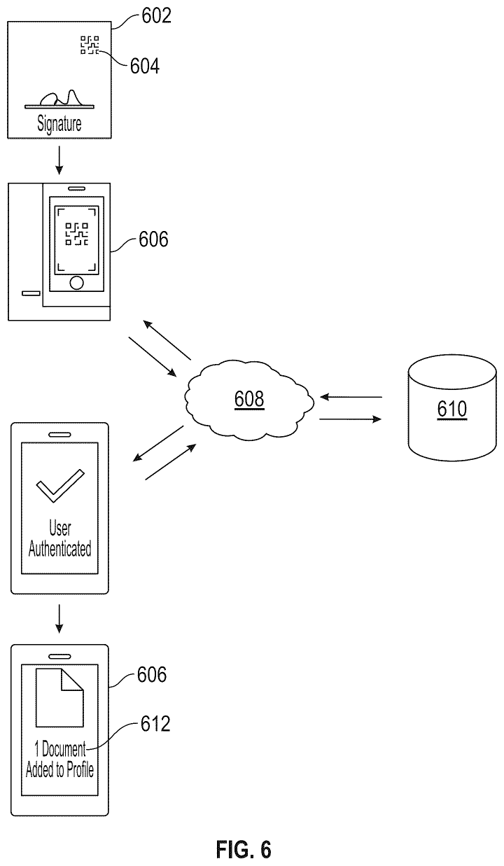

FIG. 6 illustrates the use of a physical document having an optical code for collecting wet signatures, authenticating users, and/or uploading documents to a user's profile, according to some examples. In this example, a printer driver system as described herein has annotated a document 602 with an optical code 604 that is associated with a workflow for collecting wet signatures. The document 602, has been printed and then physically signed by a possessor of the document (e.g., a recipient of the document or someone who has printed the document). The possessor of the document may then scan the optical code with an optical sensor on their computing device 606. Optionally, the system (e.g., server 608) may then send instructions to the device 606 causing device 606 to prompt the possessor of the document to take a photo of the document, including their signature. Once the user takes the photograph, then device 606 may then transmit a signal to server 608 that may include the captured image with their signature.

Server 608 may authenticate the possessor of the document 602 in various ways. For example, in a similar manner as described with respect to FIG. 5, server 608 may read identifying information (e.g., login credentials, a device ID or an IP address of the possessor's device 606) stored in the database 610 associated with that particular workflow and compare it to the device that sent the signal to the server that included the signed document. In some examples, server 608 may identify the possessor of the document from their signature and authenticate the possessor by comparing their signature on the document 602 with a representative signature stored in database 610 associated with the particular workflow. In other examples, the possessor may be prompted to enter a set of login credentials before or after scanning the optical code for authentication.

Once the possessor has been authenticated by the server 608, the digital copy of the annotated document stored in database 610 may be updated to reflect the addition of the possessor's signature, and/or additional information regarding the signature (including, e.g., verification of the signature, timestamp information, a photograph of the signature, user identity, etc.) may be stored in database 610. Optionally, the server 608 may then send a signal to the possessor's device 606 with the updated digital copy of the annotated document and instructions to display the document to the user. In some examples, the server 608 may be configured to upload the updated digital copy of the annotated document to a user profile 612 of the possessor so that the updated digital copy may be accessed through their computing device 606.

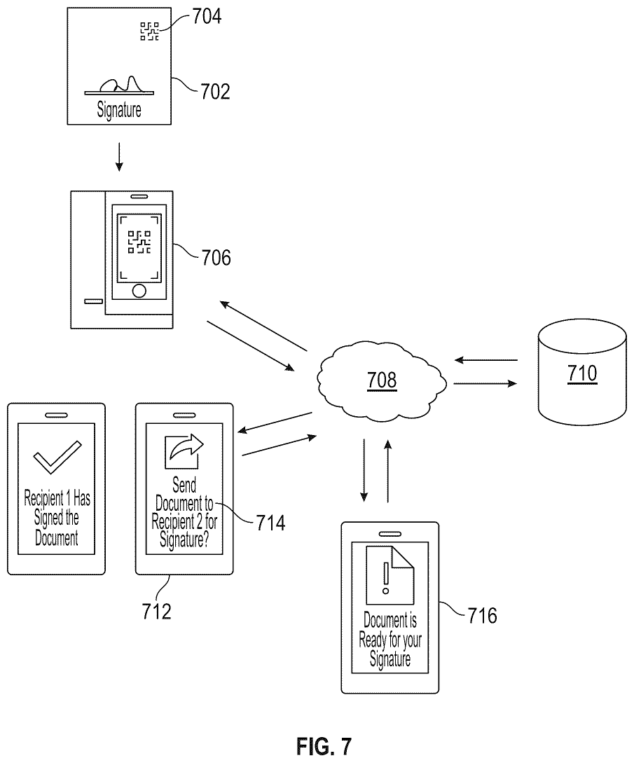

FIG. 7 illustrates the collection of multiple wet signatures on a physical document using a digital workflow. Similar to the example of FIG. 6, a document 702 has been automatically annotated by a printer driver system as described herein, such that it has an optical code 704 associated with a signature collection workflow. The document 702 has been signed by a possessor of the document. The possessor of the document 702 may scan the optical code 704 with an optical sensor on their computing device 706 and may be prompted to take a photo of the entire document, including their signature, before or after scanning the optical code 704.

The possessor's computing device 706 may then transmit a signal to server 708 that may include the captured image with their signature. Similar to the example of FIG. 5, the sender of the document may be notified that the recipient has signed the document through signals exchanged to and from the server 708 and the sender's computing device 712 in response to receiving the signal from the possessor's computing device 706. Although the examples shown in FIG. 6 and FIG. 7 involve collecting wet signatures, the optical codes on digital or physical copies of documents can be similarly scanned to prompt a user to enter their electronic signature and to send the document to the next recipient in the workflow whose electronic signature is needed.

Additionally, upon receiving the signal from the possessor's computing device 706 with the signed document by the possessor, server 708 may update the stored copy of the annotated digital document to reflect the addition of the possessor's signature in the database 710 associated with the digital workflow. Further, the server 708 may be configured to determine who the next recipient of the document should be by analyzing digital workflow data stored in the database 710. The server 708 may determine the identity of the next recipient or recipients and/or destination computing device(s) belonging to the next recipient(s). In some examples, although not shown in FIG. 7, the server 708 may be configured to automatically send the document to a destination computing device belonging to the next recipient and/or upload the document to a user profile of the next recipient.

Still referring to FIG. 7, in other examples, server 708 may send a signal instructing the display of a prompt 714 for sending a digital copy of the signed document to the next recipient at the sender's computing device 712, optionally along with visual affordances for the sender to make their selection. In other examples, server 708 may automatically send a digital copy of the signed document to the next recipient upon receiving the signal from the possessor's computing device 706 that they have signed the document. Once the server 708 receives a signal from the sender's computing device 712 indicating that the sender would like to send the document to the next recipient, the server may send a signal to a recipient computing device 716. The signal may optionally include instructions for the recipient's computing device 716 to display a notification to the user that a new document is available for their signature. The recipient may then print out a physical copy of the document, sign it with their wet signature, and these steps may be repeated for any given number of recipients (e.g., required signatories of the document). Additionally, or alternatively, documents may be routed to additional recipients via email. For example, an email may be sent to a recipient containing a URL that points to a digital copy of the document or a location within the workflow. The URL may be the same as the one encoded in the optical code on the document. By selecting the URL, a recipient may obtain information on the status of the workflow and/or may edit a document, such as by providing their electronic signature.

### Exemplary System

FIG. 8 illustrates an exemplary system 800 configured to implement the methods described herein, such as method 100. One or more components of system 800 may be located on personal-use computers (e.g., phones, tablets, etc.), in an on-premises data center, and/or distributed over a cloud computing environment. In some examples, an end user may configure one or more digital workflows using computing device 101, optionally via an end user interface displayed thereon. In other examples, as shown in FIG. 8, one or more digital workflows may be configured by the server 106. The optical code printer driver 104 may be stored on computing device 101. As mentioned above, the optical code printer driver 104 may be configured to determine whether a document already includes an optical code, indicating that it has been assigned to a digital workflow. In addition to this functionality, optical code printer driver 104 may be configured to perform functions traditionally associated with printer drivers, such as converting data in the document to be printed into a format that can be read by a printer, configuring printing settings (e.g., page count, color, etc.), receiving print commands, and communicating with a printer responsive to these commands.

System 800 may also include a printer 112 for printing physical documents. Printer 112 may be in communication with the optical code printer driver 104 via a wireless or wired connection to computing device 101. The optical code printer driver 104 may transmit signals to printer 112 including digital document data that is to be printed into a physical document. In some examples, optical code printer driver 104 may be configured for use with a particular operating system. A document to be printed may be rendered into a PDF by the optical code printer driver 104 and may be uploaded to server 106. The optical code printer driver may then leverage the printer functionality of the operating system in printing the document. In this manner, optical code printer driver 104 may be universally compatible with any model of printer that is operating on the same operating system as itself. The optical code printer driver 104 may also be configured to communicate with a server 106 over a network. In some examples, server 106 is a cloud-based server hosted by a cloud service provider (e.g., Amazon Web Services, Google Cloud Platform, Microsoft Azure, etc.). Server 106 may be in communication one or more downstream applications in facilitating the progression of the digital workflow associated with the annotated document. Server 106 may be in communication with a database 110, for example, by transmitting requests to read and/or write data to and from database 110 as the server 106 updates facilitates the progression of the digital workflow.

FIG. 9 depicts a computer, in accordance with various embodiments. Computer 900 can be a component of system 800 as described herein. For example, computing device 101 may have the same or similar components as computer 900. Computer 900 may host one or more components of the system 800, and/or may carry out part or all of the computer-implemented methods described herein. Computer 900 can be a host computer connected to a network.

Computer 900 can be a client computer or a server. As shown in FIG. 9, computer 900 can be any suitable type of microprocessor-based device, such as a personal computer, workstation, server, videogame console, or handheld computing device, such as a phone or tablet. The computer can include, for example, one or more of processor 901, computer input device 902, output device 903, storage 904, and communication device 905. Computer input device 902 can generally correspond to those described above and can either be connectable or integrated with the computer.

Computer input device 902 can be any suitable device that provides input, such as a touch screen or monitor, keyboard, mouse, or voice-recognition device. Output device 903 can be any suitable device that provides output, such as a touch screen, monitor, printer, disk drive, or speaker.

Storage 904 can be any suitable device that provides storage, such as an electrical, magnetic, or optical memory, including a RAM, cache, hard drive, CD-ROM drive, tape drive, removable storage disk, or other non-transitory computer readable medium. Storage 904 can include one storage device or more than one storage device. As used herein, the terms storage, memory, and/or storage medium/media may refer to singular and/or plural devices which may store data and/or code/instructions individually, redundantly, and/or in cooperation with one another, for example in a local and/or cloud storage environment. Communication device 905 can include any suitable device capable of transmitting and receiving signals over a network, such as a network interface chip or card. The components of the computer can be connected in any suitable manner, such as via a physical bus or wirelessly. Storage 904 can be a non-transitory computer-readable storage medium comprising one or more programs, which, when executed by one or more processors, such as processor 901, cause the one or more processors to execute methods described herein.

Software 906, which can be stored in storage 904 and executed by processor 901, can include, for example, the programming that embodies the functionality of the present disclosure (e.g., as embodied in the systems, computers, servers, and/or devices as described above). In some embodiments, software 906 can be implemented and executed on a combination of servers such as application servers and database servers.

Software 906, or part thereof, can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 904, that can contain or store programming for use by or in connection with an instruction execution system, apparatus, or device.

Software 906 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 900 can implement any operating system suitable for operating the network. Software 906 can be written in any suitable programming language, such as C, C++, Java, or Python. In various embodiments, application software embodying the functionality of the present disclosure can be deployed in different configurations, such as in a client/server arrangement or through a web browser as a Web-based application or Web service, for example.

1. A computer-implemented method, comprising:
receiving, at a printer driver, an instruction to print a digital document;
in response to receiving the instruction to print the document, automatically transmitting, by the printer driver, the digital document to a server;
annotating, by the server, the digital document with an optical code associated with a digital workflow to create an annotated digital document, wherein the optical code is configured to cause a device that scans the optical code to access stored information regarding the digital workflow;
storing, in a database associated with the digital workflow, the annotated digital document;
transmitting, by the server, the annotated digital document to the printer driver; and
transmitting, from the printer driver to a printer, a command to print a physical copy of the annotated digital document.

2. The computer-implemented method of claim 1, further comprising:
extracting, by the server, data from the digital document; and
storing, in the database associated with the digital workflow, the information extracted from the digital document.

3. The computer-implemented method of claim 1, further comprising configuring, by the server, the digital workflow, wherein configuring the digital workflow comprises one or more of the following steps: defining steps of the digital workflow, defining an order of steps of the digital workflow, defining parties associated with the digital workflow, defining permissions for different parties to the digital workflow, and defining information to be solicited from different parties to the digital workflow.

4. The computer-implemented method of claim 1, further comprising:
upon receipt of the digital document from the printer driver, automatically determining, by the server, a document type of the digital document based on digital document data; and
allocating, by the server, the digital document to the digital workflow based on the determined document type.

5. The computer-implemented method of claim 4, wherein determining, by the server, a document type of the digital document based on digital document data comprises parsing, by the server, the digital document data from the digital document.

6. The computer-implemented method of claim 1, wherein the optical code corresponds uniquely to the digital workflow.

7. The computer-implemented method of claim 1, wherein the optical code corresponds uniquely to the digital document.

8. The computer-implemented method of claim 1, wherein the optical code is a QR code, a bar code, or a bit code.

9. The computer-implemented method of claim 1, further comprising:
determining, by the server, based on the digital workflow, a destination device to receive the annotated digital document; and
transmitting, by the server, to the destination device, the annotated digital document.

10. The computer-implemented method of claim 1, further comprising:
determining, by the server, based on the digital workflow, an intended recipient to receive the annotated digital document; and
uploading, by the server, the annotated digital document to a profile associated with the intended recipient.

11. The computer-implemented method of claim 1, further comprising:
receiving, by the server, a signal from a remote device of a possessor of the physical copy of the annotated document indicating that the optical code has been scanned by the possessor; and
transmitting, by the server, a signal instructing the remote device to display a graphical user interface associated with the digital workflow.

12. The computer-implemented method of claim 11, further comprising:
receiving, by the server, from the remote device of the possessor of the physical copy, information provided via the graphical user interface associated with the digital workflow; and
storing the information provided via the graphical user interface in the database in association with the digital workflow.

13. The computer-implemented method of claim 12, further comprising:
determining, by the server, an identity of the possessor based on the signal from the remote device; and
authenticating, by the server, the possessor based on the identity of the possessor and the digital workflow,
wherein transmitting the instruction to display the graphical user interface is performed in accordance with one or both of determining and authenticating the identity of the possessor.

14. The computer-implemented method of claim 1, further comprising:
transmitting, by the server, to an end user device, a signal indicating a proposed digital workflow of the digital document and instructions for the end user device to display visual affordances for approving or rejecting the proposed digital workflow;
receiving, by the server, a signal from the end user device indicating an end user selection of the visual affordance for approving the proposed digital workflow; and
allocating, by the server, the digital document to the approved digital workflow in response to receiving the signal indicating that the proposed digital workflow has been approved.

15. The computer-implemented method of claim 1, wherein annotating, by the server, the digital document with an optical sensor associated with the digital workflow to create an annotated digital document comprises creating a PDF of the annotated digital document.

16. A system comprising:
one or more processors; and
memory storing instructions stored in the memory, which, when executed by the one or more processors, cause the system to:
receive, at a printer driver, an instruction to print a digital document;
in response to receiving the instruction to print the document, automatically transmit, by the printer driver, the digital document to a server;
annotate, by the server, the digital document with an optical code associated with a digital workflow to create an annotated digital document, wherein the optical code is configured to cause a device that scans the optical code to access stored information regarding the digital workflow;
store, in a database associated with the digital workflow, the annotated digital document;
transmit, by the server, the annotated digital document to the printer driver; and
transmit, from the printer driver to a printer, a command to print a physical copy of the annotated digital document.

17. The system of claim 16, wherein the system is further caused to:
extract, by the server, data from the digital document; and
store, in the database associated with the digital workflow, the information extracted from the digital document.

18. The system of claim 16, wherein the system is further caused to:
configure, by the server, the digital workflow, wherein configuring the digital workflow comprises one or more of the following steps: defining steps of the digital workflow, defining an order of steps of the digital workflow, defining parties associated with the digital workflow, defining permissions for different parties to the digital workflow, and defining information to be solicited from different parties to the digital workflow.

19. The system of claim 16, wherein the system is further caused to:
upon receipt of the digital document from the printer driver, automatically determine, by the server, a document type of the digital document based on digital document data; and
allocate, by the server, the digital document to the digital workflow based on the determined document type.

20. The system of claim 19, wherein determining, by the server, a document type of the digital document based on digital document data comprises parsing, by the server, the digital document data from the digital document.

21. The system of claim 16, wherein the optical code corresponds uniquely to the digital workflow.

22. The system of claim 16, wherein the optical code corresponds uniquely to the digital document.

23. The system of claim 16, wherein the optical code is a QR code, a bar code, or a bit code.

24. The system of claim 16, wherein the system is further caused to:
determine, by the server, based on the digital workflow, a destination device to receive the annotated digital document; and
transmit, by the server, to the destination device, the annotated digital document.

25. The system of claim 16, wherein the system is further caused to:
determine, by the server, based on the digital workflow, an intended recipient to receive the annotated digital document; and
upload, by the server, the annotated digital document to a profile associated with the intended recipient.

26. The system of claim 16, wherein the system is further caused to:
receive, by the server, a signal from a remote device of a possessor of the physical copy of the annotated document indicating that the optical code has been scanned by the possessor; and
transmit, by the server, a signal instructing the remote device to display a graphical user interface associated with the digital workflow.

27. The system of claim 16, wherein the system is further caused to:
receive, by the server, from the remote device of the possessor of the physical copy, information provided via the graphical user interface associated with the digital workflow; and
store the information provided via the graphical user interface in the database in association with the digital workflow.

28. The system of claim 27, wherein the system is further caused to:
determine, by the server, an identity of the possessor based on the signal from the remote device; and
authenticate, by the server, the possessor based on the identity of the possessor and the digital workflow,
wherein transmitting the instruction to display the graphical user interface is performed in accordance with one or both of determining and authenticating the identity of the possessor.

29. The system of claim 16, wherein the system is further caused to:
transmit, by the server, to an end user device, a signal indicating a proposed digital workflow of the digital document and instructions for the end user device to display visual affordances for approving or rejecting the proposed digital workflow;
receive, by the server, a signal from the end user device indicating an end user selection of the visual affordance for approving the proposed digital workflow; and
allocate, by the server, the digital document to the approved digital workflow in response to receiving the signal indicating that the proposed digital workflow has been approved.

30. The system of claim 16, wherein annotating, by the server, the digital document with an optical sensor associated with the digital workflow to create an annotated digital document comprises creating a PDF of the annotated digital document.

31. A computer-implemented method comprising:
receiving, via an email client program, an instruction to email a digital document;
in response to the email client program receiving the instruction to send the document, automatically transmitting, by an email plugin, the digital document to a server;
annotating, by the server, the digital document with an optical code associated with a digital workflow to create an annotated digital document, wherein the optical code is configured to cause a device that scans the optical code to access stored information regarding the digital workflow;
storing, in a database associated with the digital workflow, the annotated digital document;
transmitting, by the server, the annotated digital document to the email plugin; and
sending, by the email client program, an email comprising the annotated digital document.

32. A computer-implemented method, comprising:
receiving, at a printer driver, an instruction to print a digital document;
in response to receiving the instruction to print the document, automatically transmitting, by the printer driver, the digital document to a server;
storing, in a database associated with a digital workflow, the digital document;
transmitting, by the server, an instruction to the printer driver to annotate the document with an optical code associated with the digital workflow to create an annotated digital document, wherein the optical code is configured to cause a device that scans the optical code to access stored information regarding the digital workflow;
annotating, by the printer driver, the digital document with the optical code; and
transmitting, from the printer driver to a printer, a command to print a physical copy of the annotated digital document.

33. A system comprising:
one or more processors; and
memory storing instructions, which, when executed by the one or more processors, cause the system to:
receive, at a printer driver, an instruction to print a digital document;
in response to receiving the instruction to print the document, automatically transmit, by the printer driver, the digital document to a server;
store, in a database associated with a digital workflow, the digital document;
transmit, by the server, an instruction to the printer driver to annotate the document with an optical code associated with the digital workflow to create an annotated digital document, wherein the optical code is configured to cause a device that scans the optical code to access stored information regarding the digital workflow;
annotate, by the printer driver, the digital document with the optical code; and
transmit, from the printer driver to a printer, a command to print a physical copy of the annotated digital document.

34. A non-transitory computer-readable storage medium storing instructions that, when executed by one or more processors of a system comprising memory, cause the system to:
receive, at a printer driver, an instruction to print a digital document;
in response to receiving the instruction to print the document, automatically transmit, by the printer driver, the digital document to a server;
store, in a database associated with a digital workflow, the digital document;
transmit, by the server, an instruction to the printer driver to annotate the document with an optical code associated with the digital workflow to create an annotated digital document, wherein the optical code is configured to cause a device that scans the optical code to access stored information regarding the digital workflow;
annotate, by the printer driver, the digital document with the optical code; and
transmit, from the printer driver to a printer, a command to print a physical copy of the annotated digital document.

35. A computer-implemented method, comprising:
receiving, at a printer driver, an instruction to print a digital document;
in response to receiving the instruction to print the document:
automatically annotating the document with an optical code associated with a digital workflow to create an annotated digital document, wherein the optical code is configured to cause a device that scans the optical code to access stored information regarding the digital workflow; and
automatically storing, in a database associated with the digital workflow, the digital document; and
transmitting, from the printer driver to a printer, a command to print a physical copy of the annotated digital document.

36. A system comprising:
one or more processors;
memory storing instructions, which, when executed by the one or more processors, cause the system to:
receive, at a printer driver, an instruction to print a digital document;
in response to receiving the instruction to print the document:
automatically annotate the document with an optical code associated with a digital workflow to create an annotated digital document, wherein the optical code is configured to cause a device that scans the optical code to access stored information regarding the digital workflow; and
automatically store, in a database associated with the digital workflow, the digital document; and
transmit, from the printer driver to a printer, a command to print a physical copy of the annotated digital document.

37. A non-transitory computer-readable storage medium storing instructions that, when executed by one or more processors of a system comprising memory, cause the system to:
receive, at a printer driver, an instruction to print a digital document;
in response to receiving the instruction to print the document:
automatically annotate the document with an optical code associated with a digital workflow to create an annotated digital document, wherein the optical code is configured to cause a device that scans the optical code to access stored information regarding the digital workflow; and
automatically store, in a database associated with the digital workflow, the digital document; and
transmit, from the printer driver to a printer, a command to print a physical copy of the annotated digital document.
